(19) United States
(12) Patent Application Publication
(10) Pub. No.: US 2020/0322122 A1
(43) Pub. Date: Oct. 8, 2020

(54) DATA TRANSMISSION DEVICE AND DATA TRANSMISSION METHOD

(71) Applicant: MITSUBISHI ELECTRIC CORPORATION, Tokyo (JP)

(72) Inventor: Tomotaka OGAWA, Tokyo (JP)

(73) Assignee: MITSUBISHI ELECTRIC CORPORATION, Tokyo (JP)

(21) Appl. No.: 16/652,181

(22) PCT Filed: Nov. 22, 2017
(86) PCT No.: PCT/JP2017/042020

§ 371 Date: Mar. 30, 2020

(51) Int. Cl. H04L 7/00

(52) U.S. Cl. CPC H04L 7/0041; H04L 7/0091

(57) ABSTRACT

A data transmission device includes an embedded clock-scheme differential signal transmission circuit and an in-phase signal transmission circuit. The data transmission device accepts transmission-object data and a transmission instruction for the data. Then, the data transmission device determines between the embedded clock-scheme differential signal transmission circuit and the in-phase signal transmission circuit, by which circuit to transmit the data, based on at least either one of the data and the transmission instruction. The data transmission device causes the determined circuit to transmit the data.

### TECHNICAL FIELD

The present invention relates to a device-to-device data transmission technique.

### BACKGROUND ART

Non-Patent Literature 1 describes an embedded clock-scheme differential signal transmission circuit which is a circuit for transmitting data between devices such as computers. An embedded clock-scheme differential signal transmission circuit solves a problem of unable to set very high a clock frequency in a serial transmission circuit, so that data can be transmitted at high speed.

Patent Literature 1 describes adding, to a potential midpoint on a transmission side of a differential signal transmission circuit, a separate in-phase signal transmission circuit. Hence, in Patent Literature 1, both a differential signal and an in-phase signal can be transferred via a pair of signal lines, thereby reducing a number of signal lines.

### CITATION LIST

### Patent Literature

Patent Literature 1: JP 2002-204272 A

### Non-Patent Literature

HATAKEYAMA, Hitoshi et al, “PCI Express Sekkei no Kiso to Ouyou”, CQ Publisher, issued on May 15, 2010, pp. 25 to 51

### SUMMARY OF INVENTION

### Technical Problem

An embedded clock-scheme differential signal transmission circuit is configured by adding several circuits to a transmission side and reception side of a serial transmission circuit. Since a processing delay occurs in the added circuits, it takes time from the transmission side starts transmission of data until the data starts arriving at the reception side.

When transmitting a large amount of data, it is possible to perform high-speed transmission in which the processing delay occurring in the added circuits is compensated for. However, when transmitting a small amount of data, the transmission will be completed before the processing delay in the added circuits is recovered. That is, when transmitting a small amount of data, if an embedded clock-scheme differential signal transmission circuit is employed, it will only prolong the transmission time.

An objective of the present invention is to enable high-speed transmission of a small amount of data while enabling high-speed transmission of a large amount of data.

### Solution to Problem

A data transmission device according to the present invention includes:

a data accepting unit to accept data;

an instruction accepting unit to accept a transmission instruction for the data accepted by the data accepting unit;

a transmission method determination unit to determine between an embedded clock-scheme differential signal transmission circuit and an in-phase signal transmission circuit, by which circuit to transmit the data, based on at least either one of the data and the transmission instruction accepted by the instruction accepting unit; and

an instruction execution unit to cause the circuit determined by transmission method determination unit, to transmit the data.

### Advantageous Effects of Invention

According to the present invention, between an embedded clock-scheme differential signal transmission circuit and an in-phase signal transmission circuit, by which circuit to transmit data is switched based on at least either one of transmission-object data and a transmission instruction. This enables high-speed transmission of a small amount of data while enabling high-speed transmission of a large amount of data.

### BRIEF DESCRIPTION OF DRAWINGS

FIG. 1 is an explanatory diagram of connection of computers 50.

FIG. 2 is an explanatory diagram of I/Fs 51.

FIG. 3 is a configuration diagram of a serial transmission circuit 60.

FIG. 4 is a configuration diagram of a transmission-side circuit 71 in an embedded clock-scheme differential signal transmission circuit 70.

FIG. 5 is a configuration diagram of a reception-side circuit 75 in the embedded clock-scheme differential signal transmission circuit 70.

FIG. 6 is an explanatory diagram of transmission of a large amount of data.

FIG. 7 is an explanatory diagram of transmission of a small amount of data.

FIG. 8 is a diagram indicating comparison between the serial transmission circuit 60 and the embedded clock-scheme differential signal transmission circuit 70.

FIG. 9 is a configuration diagram of a transmission-side circuit 20 in a data transmission device 10 according to Embodiment 1.

FIG. 10 is a configuration diagram of a reception-side circuit 30 in the data transmission device 10 according to Embodiment 1.

FIG. 11 is a flowchart illustrating behavior of the data transmission device 10 according to Embodiment 1.

FIG. 12 is a diagram illustrating a transmission instruction according to Embodiment 1.

FIG. 13 is a flowchart illustrating behavior of a data transmission device 10 according to Embodiment 2.

FIG. 14 is a flowchart illustrating behavior of a data transmission device 10 according to Embodiment 3.

FIG. 15 is a flowchart illustrating behavior of a data transmission device 10 according to Embodiment 4.

FIG. 16 is a configuration diagram of a data transmission device 10 according to Embodiment 5.

### DESCRIPTION OF EMBODIMENTS

### Embodiment 1

***Outline Description***

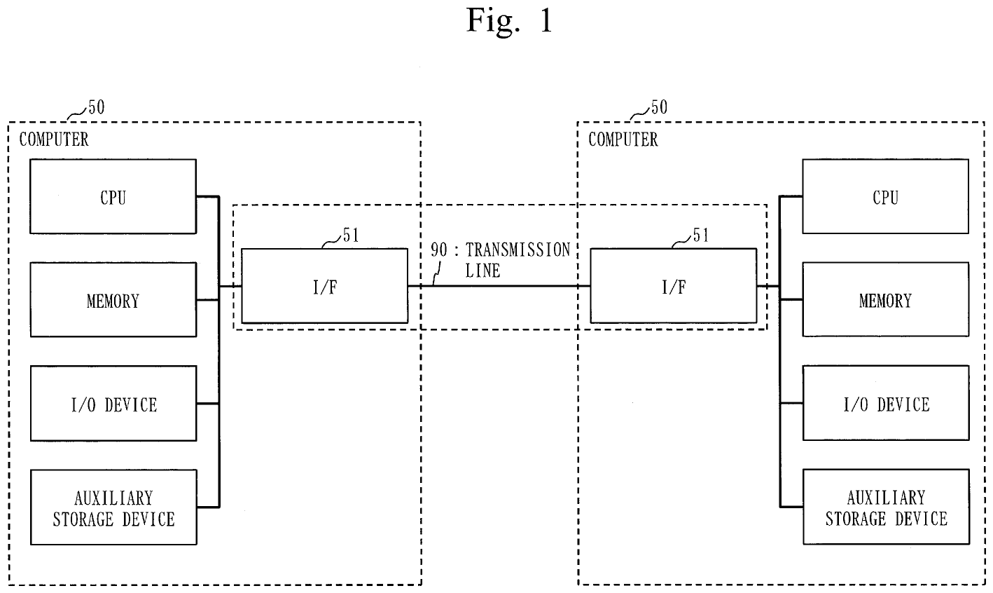

An outline of data transmission will be described with referring to FIGS. 1 to 8.

As illustrated in FIG. 1, when connecting two computers 50, interfaces (1/Fs) 51 are provided to the computers, respectively, and the UFs 51 are connected via a transmission line 90.

FIG. 1 illustrates a configuration in which each computer 50 is provided with a central processing unit (CPU), a memory, an I/O device, and an auxiliary storage device. However, the configuration of the computer 50 is not limited to that illustrated in FIG. 1. A case where the computer 50 is provided with other constituent elements is possible, and a case where the computer 50 is not provided with some of the constituent elements is also possible. A case where the computer 50 is some apparatus, is one integrated circuit (IC), or is a large-scale integration (LSI) is also possible.

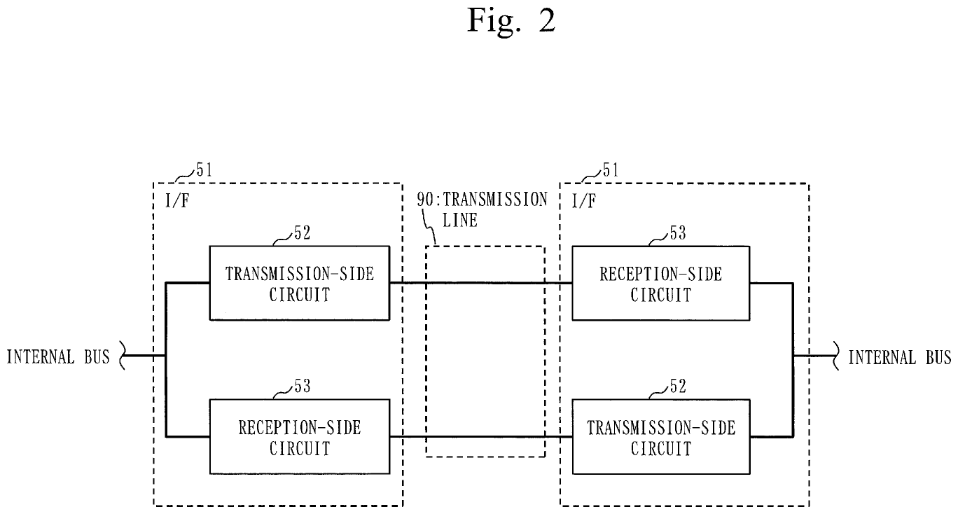

As illustrated in FIG. 2, each I/F 51 is provided with a transmission-side circuit 52 and a reception-side circuit 53. The transmission-side circuit 52 in one I/F 51 and the reception-side circuit 53 in the other I/F 51 are connected via the transmission line 90.

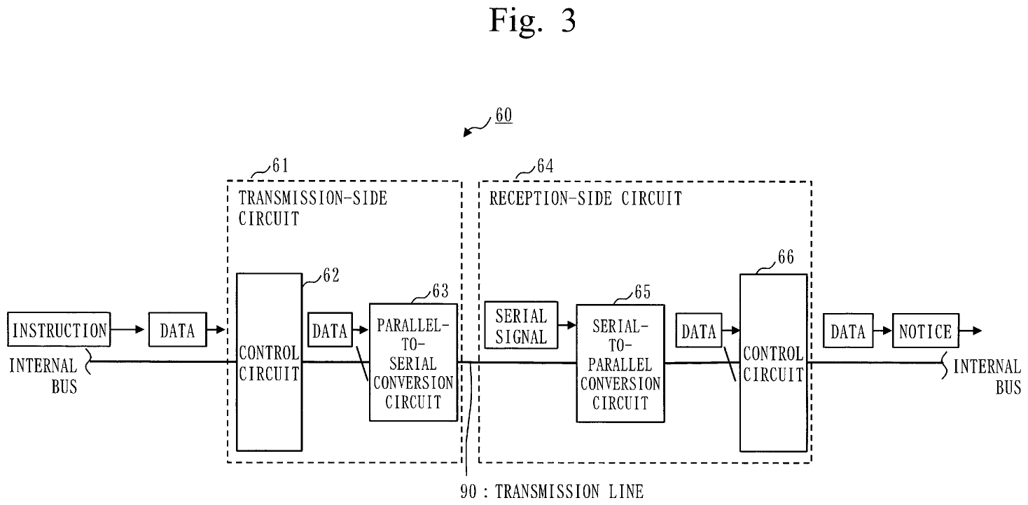

As illustrated in FIG. 3, in a serial transmission circuit 60, a transmission-side circuit 61 is provided with a control circuit 62 and a parallel-to-serial conversion circuit 63. A reception-side circuit 64 is provided with a serial-to-parallel conversion circuit 65 and a control circuit 66.

In the transmission-side circuit 61, the control circuit 62 receives transmission-object data and a transmission instruction indicating a data size and so on. Then, based on the transmission instruction, the parallel-to-serial conversion circuit 63 converts the data as a parallel signal into a serial signal and supplies the serial signal onto a transmission line 90. In the reception-side circuit 64, upon reception of the serial signal from the transmission line 90, the serial-to-parallel conversion circuit 65 converts the serial signal into a parallel signal. Then, the control circuit 66 supplies a notice notifying that the data is received, and the data, to a data bus in a computer 50 (to be referred to as internal bus hereinafter).

The serial transmission circuit 60 has a problem of unable to set very high a frequency of a clock signal used for data transmission.

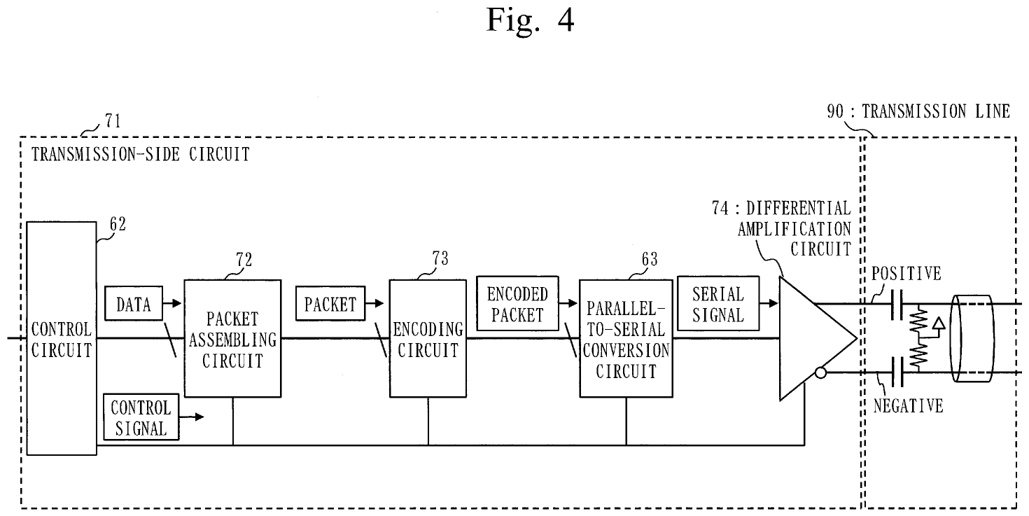

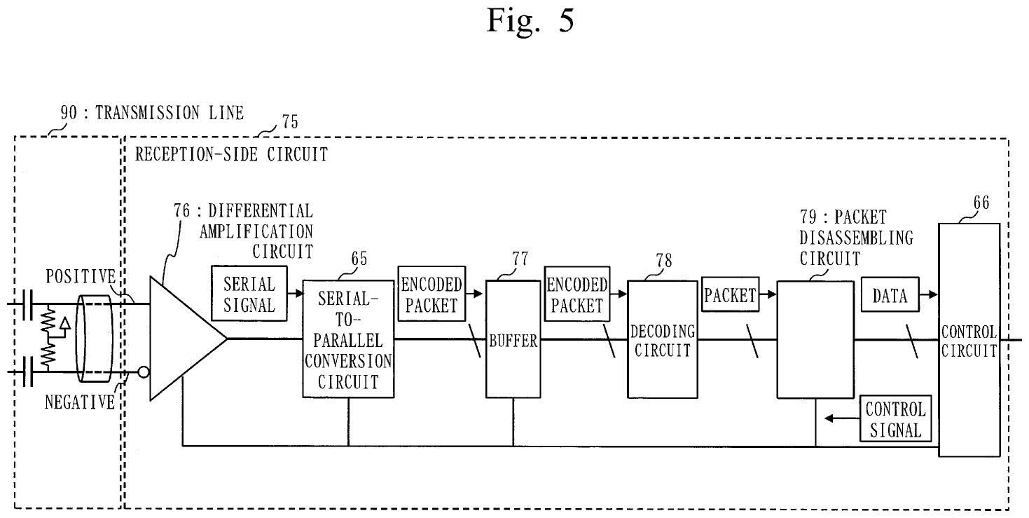

As illustrated in FIG. 4, in an embedded clock-scheme differential signal transmission circuit 70, a transmission-side circuit 71 is configured by adding a packet assembling circuit 72, an encoding circuit 73, and a differential amplification circuit 74 to the transmission-side circuit 61 of the serial transmission circuit 60. As illustrated in FIG. 5, in the embedded clock-scheme differential signal transmission circuit 70, a reception-side circuit 75 is configured by adding a differential amplification circuit 76, a buffer 77, a decoding circuit 78, and a packet disassembling circuit 79 to the reception-side circuit 64 of the serial transmission circuit 60.

In the transmission-side circuit 71, the control circuit 62 receives transmission-object data and a transmission instruction indicating a data size and so on. Then, the packet assembling circuit 72 assembles a packet from the data, and the encoding circuit 73 encodes the packet by the embedded clock scheme. The parallel-to-serial conversion circuit 63 converts the encoded packet into a serial signal. The differential amplification circuit 74 amplifies a differential output and supplies the amplified differential output to the transmission line 90. In the reception-side circuit 75, the differential amplification circuit 76 amplifies a differential input received from the transmission line 90. The serial-to-parallel conversion circuit 65 converts the serial signal into a parallel signal and outputs the parallel signal to the buffer 77. Then, the decoding circuit 78 decodes the embedded clock-scheme signal to generate a packet. The packet disassembling circuit 79 disassembles the packet to generate data. The control circuit 66 supplies a notice notifying that the data is received, and the data, to the internal bus of the computer 50.

The embedded clock-scheme differential signal transmission circuit 70 can perform data transmission using a high-frequency clock signal and accordingly can transmit a large amount of data within a short period of time.

In the embedded clock-scheme differential signal transmission circuit 70, a processing delay occurs in the circuits added to the serial transmission circuit 60, and the delay increases accordingly. Therefore, in the embedded clock-scheme differential signal transmission circuit 70, time taken after the transmission side starts transmission of data until the data starts arriving at the reception side is prolonged, as compared to in the serial transmission circuit 60.

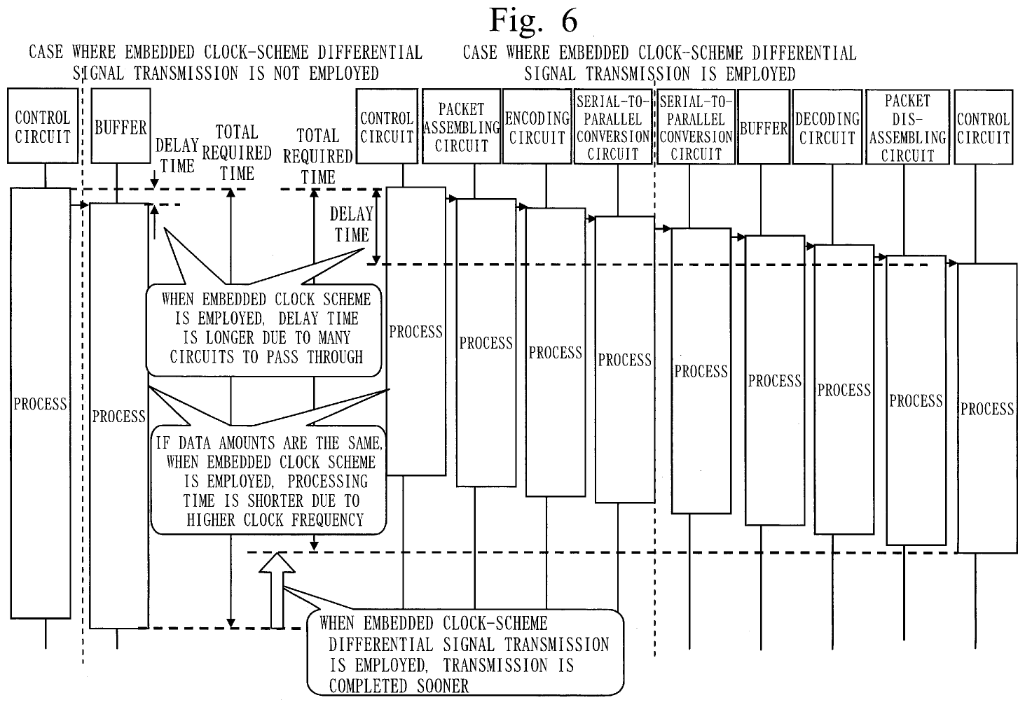

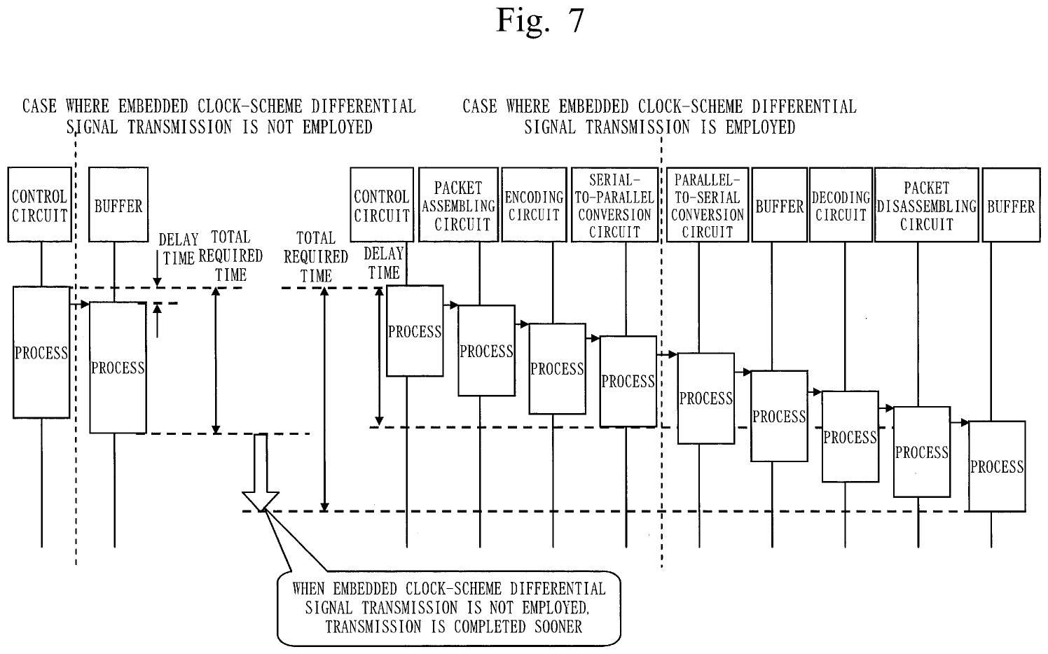

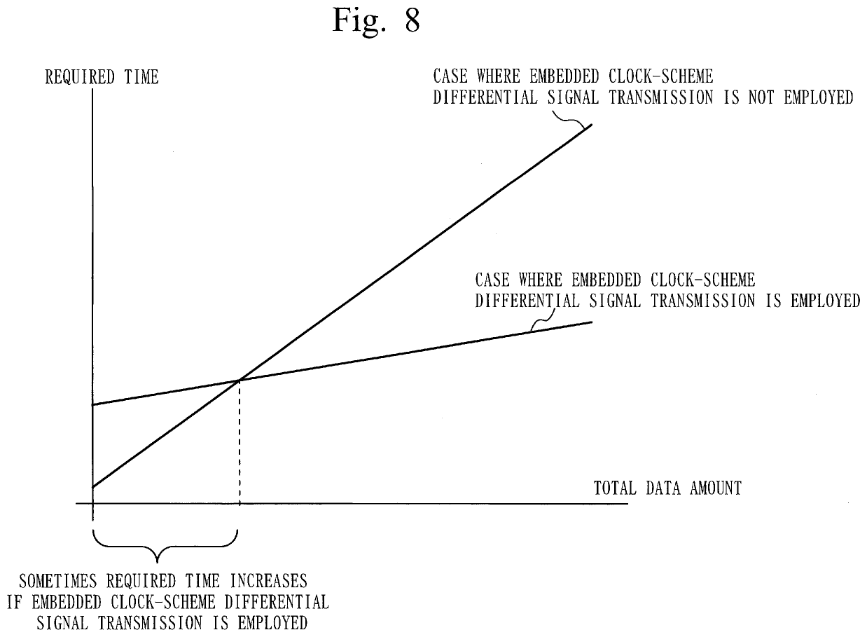

In view of this, as illustrated in FIG. 6, when transmitting a large amount of data, it is possible to perform high-speed transmission in the processing delay in the added circuits is compensated for. However, as illustrated in FIG. 7, when transmitting a small amount of data, the transmission will be completed before the processing delay in the added circuits is recovered. That is, when transmitting a small amount of data, if an embedded clock-scheme differential signal transmission circuit is employed, it will only prolong the transmission time, as illustrated in FIG. 8.

Therefore, with the embedded clock-scheme differential signal transmission circuit 70, when transmitting a small amount of data as in a process of checking a behavior status, sometimes the processing time becomes long. Also, when a small delay is requested as in control of a driving apparatus, sometimes it is difficult to use the embedded clock-scheme differential signal transmission circuit 70.

***Description of Configuration***

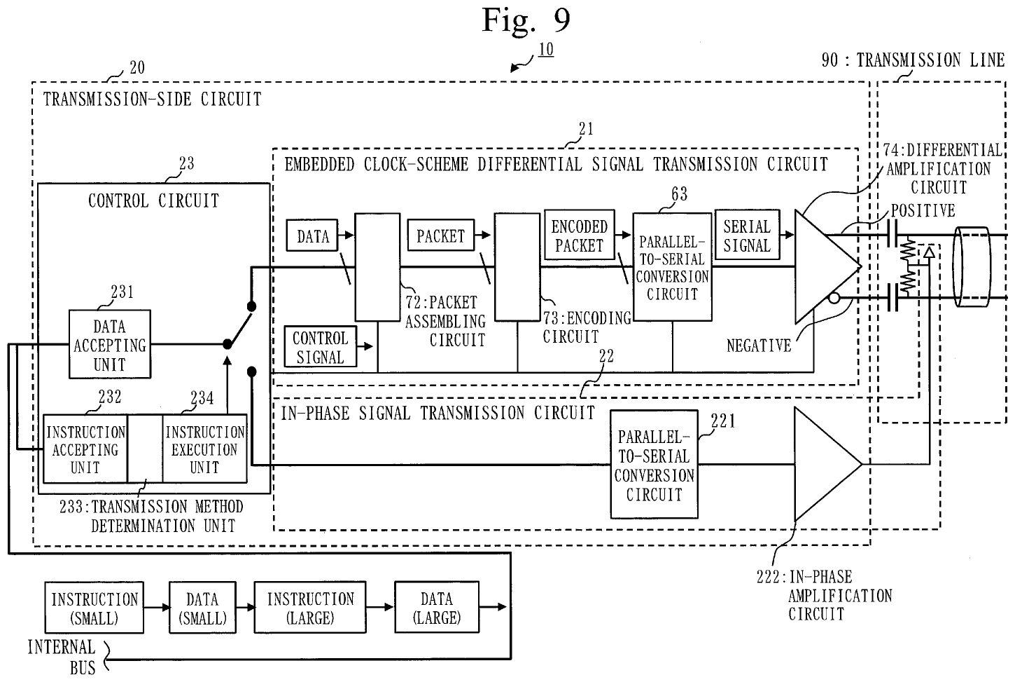

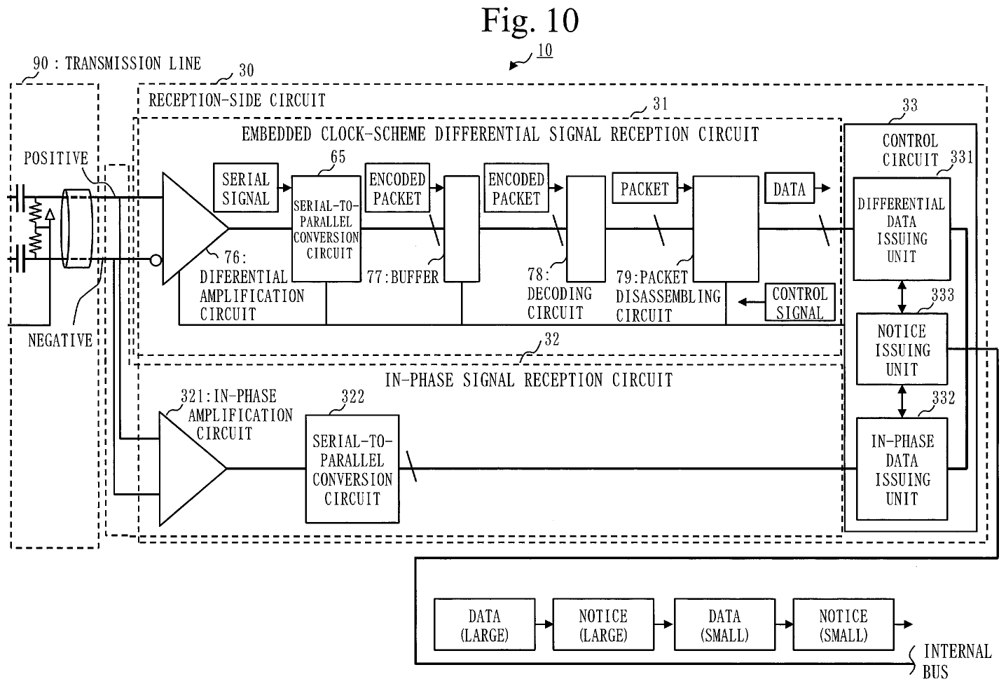

A configuration of a data transmission device 10 according to Embodiment 1 will be described with referring to FIGS. 9 and 10.

The data transmission device 10 is a device provided to the I/F 51 of the computer 50.

As illustrated in FIG. 9, a transmission-side circuit 20 of the data transmission device 10 is provided with an embedded clock-scheme differential signal transmission circuit 21, an in-phase signal transmission circuit 22, and a control circuit 23.

The embedded clock-scheme differential signal transmission circuit 21 has a configuration obtained by removing the control circuit 62 from the transmission-side circuit 71 of the embedded clock-scheme differential signal transmission circuit 70 described with referring to FIG. 4. That is, the embedded clock-scheme differential signal transmission circuit 21 is provided with the packet assembling circuit 72, the encoding circuit 73, the parallel-to-serial conversion circuit 63, and the differential amplification circuit 74.

The in-phase signal transmission circuit 22 is provided with a parallel-to-serial conversion circuit 221 and an in-phase amplification circuit 222. The in-phase signal transmission circuit 22 is connected to a transmission-side potential midpoint of the embedded clock-scheme differential signal transmission circuit 21.

Being provided with the embedded clock-scheme differential signal transmission circuit 21 and the in-phase signal transmission circuit 22, the transmission-side circuit 20 can transmit both a differential signal and an in-phase signal via a pair of signal lines.

The control circuit 23 is provided with a data accepting unit 231, an instruction accepting unit 232, a transmission method determination unit 233, and an instruction execution unit 234, as function constituent elements. The control circuit 23 transmits the transmission-object data via either the embedded clock-scheme differential signal transmission circuit 21 or the in-phase signal transmission circuit 22.

The function constituent elements of the control circuit 23 may be implemented by an electronic circuit or by software. When the function constituent elements of the control circuit 23 are implemented by software, the control circuit 23 is provided with a processor. The processor reads and executes software that implements the function constituent elements.

The processor and the electronic circuit are called processing circuitry. Hence, the function constituent elements of the control circuit 23 are implemented by the processing circuitry.

As illustrated in FIG. 10, a reception-side circuit 30 of the data transmission device 10 is provided with an embedded clock-scheme differential signal reception circuit 31, an in-phase signal reception circuit 32, and a control circuit 33.

The embedded clock-scheme differential signal reception circuit 31 has a configuration obtained by removing the control circuit 66 from the reception-side circuit 75 of the embedded clock-scheme differential signal transmission circuit 70 described with referring to FIG. 5. That is, the embedded clock-scheme differential signal reception circuit 31 is provided with the differential amplification circuit 76, the serial-to-parallel conversion circuit 65, the buffer 77, the decoding circuit 78, and the packet disassembling circuit 79.

The in-phase signal reception circuit 32 is provided with an in-phase amplification circuit 321 and a serial-to-parallel conversion circuit 322. The in-phase signal reception circuit 32 is connected to a reception side of the embedded clock-scheme differential signal reception circuit 31.

Being provided with the embedded clock-scheme differential signal reception circuit 31 and the in-phase signal reception circuit 32, the reception-side circuit 30 can receive both a differential signal and an in-phase signal via a pair of signal lines.

The control circuit 33 is provided with a differential data issuing unit 331, an in-phase data issuing unit 332, and a notice issuing unit 333, as function constituent elements. The control circuit 33 supplies a notice notifying that data is received, and the data, to an internal bus of the computer 50.

The function constituent elements of the control circuit 33 may be implemented by an electronic circuit or by software. When the function constituent elements of the control circuit 33 are implemented by software, the control circuit 33 is provided with a processor. The processor reads and executes software that implements the function constituent elements.

The processor and the electronic circuit are called processing circuitry. Hence, the function constituent elements of the control circuit 33 are implemented by the processing circuitry.

***Description of Behavior***

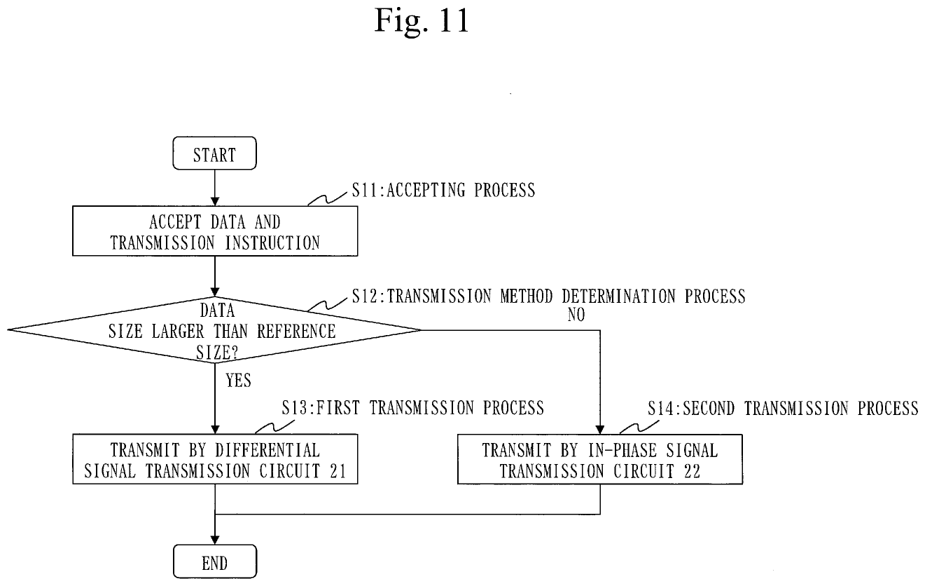

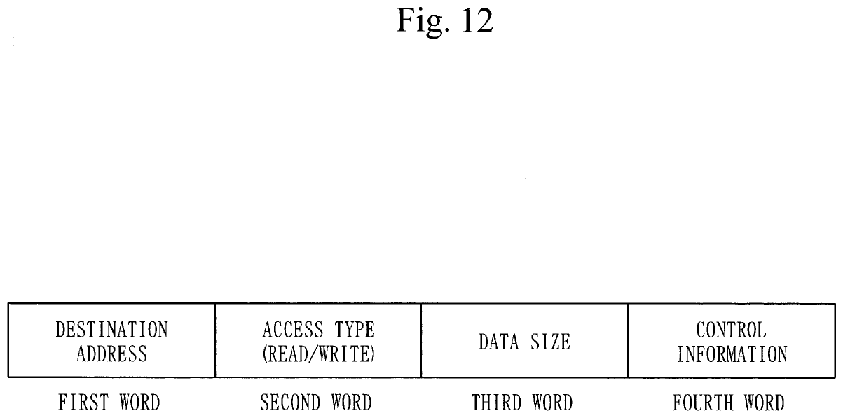

Behavior of the data transmission device 10 according to Embodiment 1 will be described with referring to FIGS. 11 and 12.

The behavior of the data transmission device 10 according to Embodiment 1 corresponds to a data transmission method according to Embodiment 1. The behavior of the data transmission device 10 according to Embodiment 1 also corresponds to a process of a data transmission program according to Embodiment 1.

(Step S11 of FIG. 11: Accepting Process)

The data accepting unit 231 accepts transmission-object data from the internal bus of the computer 50. The instruction accepting unit 232 accepts, from the internal bus of the computer 50, a transmission instruction for the transmission-object data.

As illustrated in FIG. 12, in the transmission instruction, for example, a destination address, an access type, a data size, and control information are set in the first word, the second word, the third word, and the fourth word, respectively. The destination address is an address such as a media access control (MAC) address and an Internet protocol (IP) address of a data transmission destination. The access type indicates read or write of the data. The data size is a data size of the transmission object. The control information indicates whether or not requesting a small delay.

(Step S12 of FIG. 11: Transmission Method Determination Process)

The transmission method determination unit 233 determines between the embedded clock-scheme differential signal transmission circuit 21 and the in-phase signal transmission circuit 22, by which circuit to transmit the data, based on at least either one of the transmission-object data and the transmission instruction which are accepted in step S11.

In Embodiment 1, the transmission method determination unit 233 determines by which circuit to transmit the data, depending on whether or not the data size of the transmission-object data accepted in step S11 is larger than a reference size. Specifically, in a case where the data size of the data is larger than the reference size, the transmission method determination unit 233 determines to transmit the data by the embedded clock-scheme differential signal transmission circuit 21. In a case where the data size of the data is equal to or smaller than the reference size, the transmission method determination unit 233 determines to transmit the data by the in-phase signal transmission circuit 22.

If it is determined to transmit data by the embedded clock-scheme differential signal transmission circuit 21, the transmission method determination unit 233 advances processing to step S13. If it is determined to transmit data by the in-phase signal transmission circuit 22, the transmission method determination unit 233 advances processing to step S14.

(Step S13 of FIG. 11: First Transmission Process)

The instruction execution unit 234 causes the embedded clock-scheme differential signal transmission circuit 21 determined in step S12 to transmit the data.

Specifically, the instruction execution unit 234 outputs data to the embedded clock-scheme differential signal transmission circuit 21. Then, in the embedded clock-scheme differential signal transmission circuit 21, the packet assembling circuit 72 assembles a packet from the data, and the encoding circuit 73 encodes the packet by the embedded clock scheme. The parallel-to-serial conversion circuit 63 converts the encoded packet into a serial signal. The differential amplification circuit 74 amplifies a differential output and supplies the amplified differential signal to the transmission line 90.

After that, the embedded clock-scheme differential signal reception circuit 31 of the reception-side circuit 30 in the destination-side data transmission device 10 receives data from the transmission line 90. Specifically, in the embedded clock-scheme differential signal reception circuit 31, the differential amplification circuit 76 amplifies a differential input received from the transmission line 90. The serial-to-parallel conversion circuit 65 converts the serial signal into a parallel signal and outputs the parallel signal to the buffer 77. Then, the decoding circuit 78 decodes the embedded clock-scheme signal to generate a packet, and the packet disassembling circuit 79 disassembles the packet to generate data. The generated data arrives at the differential data issuing unit 331. By monitoring the differential data issuing unit 331 or receiving a data arrival notice from the differential data issuing unit 331, the notice issuing unit 333 recognizes that the data has arrived at the differential data issuing unit 331. Then, the notice issuing unit 333 supplies a notice notifying that the data is received, and the data, to the internal bus of the computer 50.

(Step S14 of FIG. 11: Second Transmission Process)

The instruction execution unit 234 causes the in-phase signal transmission circuit 22 determined in step S12 to transmit data.

Specifically, the instruction execution unit 234 performs outputting to the in-phase signal transmission circuit 22. Then, in the in-phase signal transmission circuit 22, the parallel-to-serial conversion circuit 221 converts the data into a serial signal. The in-phase amplification circuit 222 amplifies an in-phase output and supplies the amplified output to the transmission line 90.

After that, the in-phase signal reception circuit 32 of the reception-side circuit 30 in the destination-side data transmission device 10 receives the data from the transmission line 90. Specifically, in the in-phase signal reception circuit 32, the in-phase amplification circuit 321 amplifies the in-phase input signal received from the transmission line 90, and the serial-to-parallel conversion circuit 322 converts the serial signal into a parallel signal to generate data. The generated data arrives at the in-phase data issuing unit 332. By monitoring the in-phase data issuing unit 332 or receiving a data arrival notice from the in-phase data issuing unit 332, the notice issuing unit 333 recognizes that the data has arrived at the in-phase data issuing unit 332. Then, the notice issuing unit 333 supplies a notice notifying that the data is received, and the data, to the internal bus of the computer 50.

### Effect of Embodiment 1

As described above, when the amount of transmission-object data is large, the data transmission device 10 according to Embodiment 1 transmits the data by the embedded clock-scheme differential signal transmission circuit 21 capable of high-speed transmission. When the amount of transmission-object data is small, the data transmission device 10 according to Embodiment 1 transmits the data by the in-phase signal transmission circuit 22 with a small delay.

This enables high-speed transmission of a small amount of data while enabling high-speed transmission of a large amount of data. Therefore, even in transmitting a small amount of data as in, for example, a process of checking a behavior status, a processing time is not prolonged. Also, the data transmission device 10 can be used even when a small delay is requested as in control of a driving apparatus.

### Embodiment 2

In Embodiment 2, by which circuit to transmit data is determined based on a transmission instruction. This is where Embodiment 2 is different from Embodiment 1. In Embodiment 2, this difference will be described, and a description on the same point will be omitted.

***Description of Behavior***

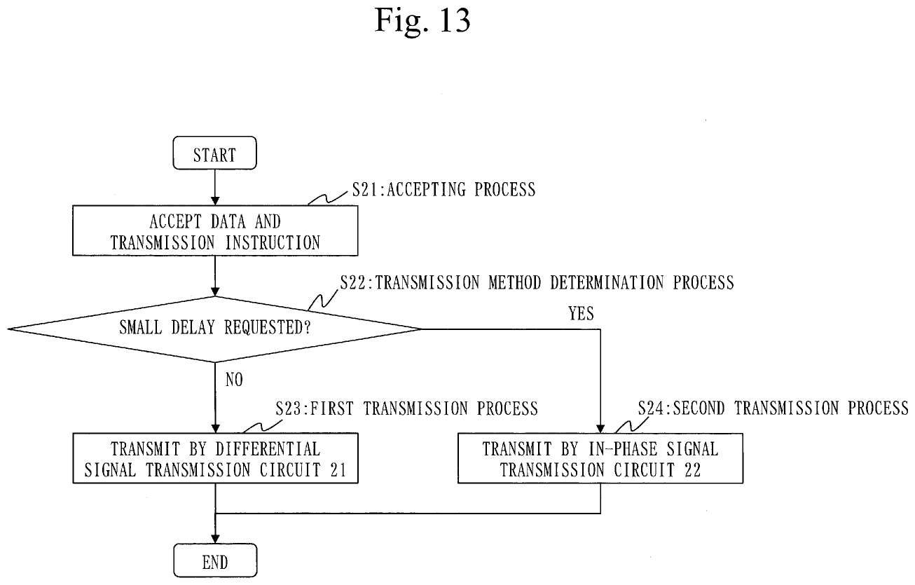

Behavior of a data transmission device 10 according to Embodiment 2 will be described with referring to FIG. 13.

A process of step S21, a process of step S23, and a process of step S24 of FIG. 13 are respectively the same as a process of step S11, a process of step S13, and a process of step S14 of FIG. 11.

(Step S22 of FIG. 13: Transmission Method Determination Process)

A transmission method determination unit 233 determines by which circuit to transmit data, based on whether or not control information included in the transmission instruction accepted in step S21 requests a small delay. Specifically, in a case where the control information indicates not requesting a small delay, the transmission method determination unit 233 determines to transmit the data by an embedded clock-scheme differential signal transmission circuit 21. In a case where the control information indicates requesting a small delay, the transmission method determination unit 233 determines to transmit the data by an in-phase signal transmission circuit 22.

### Effect of Embodiment 2

As described above, when the control information included in the transmission instruction requests a small delay, the data transmission device 10 according to Embodiment 2 transmits data by the in-phase signal reception circuit 32. Hence, when a small delay is requested, the delay time can be reliably suppressed. On the other hand, when a small delay is not requested, data can be transmitted at high speed.

### Embodiment 3

In Embodiment 3, by which circuit to transmit data is determined based on both transmission-object data and a transmission instruction. This is where Embodiment 3 is different from Embodiments 1 and 2. In Embodiment 3, this difference will be described, and a description on the same point will be omitted. In Embodiment 3, the difference from Embodiment 1 will be described.

***Description of Behavior***

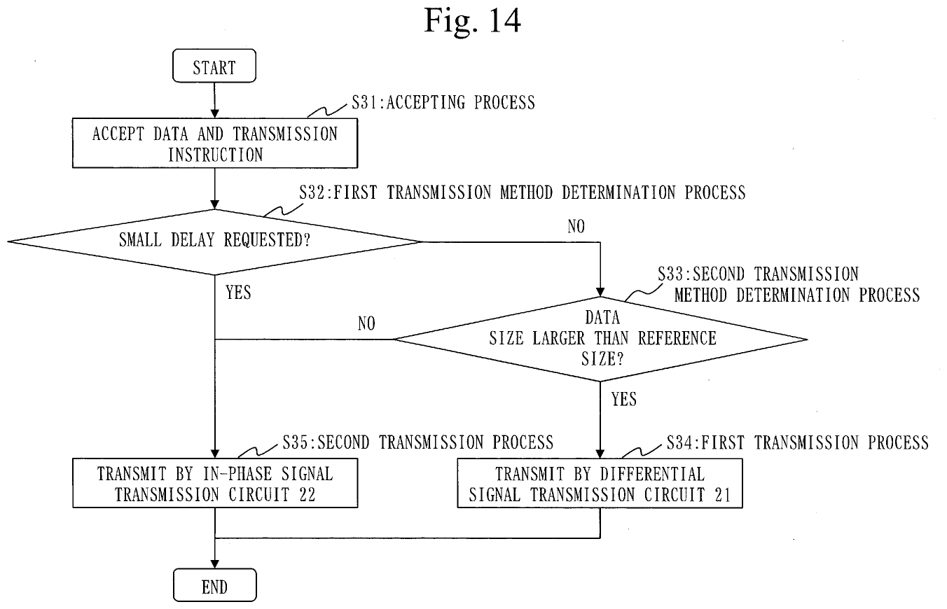

Behavior of a data transmission device 10 according to Embodiment 3 will be described with referring to FIG. 14.

A process of step S31, a process of step S34, and a process of step S35 of FIG. 14 are respectively the same as a process of step S11, a process of step S13, and a process of step S14 of FIG. 11.

(Step S32 of FIG. 14: First Transmission Method Determination Process)

A transmission method determination unit 233 transmission method determination unit 233 determines whether or not control information included in a transmission instruction accepted in step S31 indicates requesting a small delay.

If the control information does not request a small delay, the transmission method determination unit 233 advances processing to step S33. On the other hand, if the control information requests a small delay, the transmission method determination unit 233 advances processing to step S35. That is, in a case where the control information requests a small delay, the transmission method determination unit 233 determines to transmit data by an in-phase signal reception circuit 32.

(Step S33 of FIG. 14: Second Transmission Method Determination Process)

The transmission method determination unit 233 transmission method determination unit 233 determines whether or not a data size of transmission-object data accepted in step S31 is larger than a reference size.

If the data size of the data is equal to or smaller than the reference size, the transmission method determination unit 233 advances processing to step S35. That is, in a case where the control information indicates not requesting a small delay and the data size of the data is equal to or smaller than the reference size, the transmission method determination unit 233 determines to transmit data by the in-phase signal reception circuit 32. On the other hand, if the data size of the data is larger than the reference size, the transmission method determination unit 233 advances processing to step S34. That is, in a case where the control information indicates not requesting a small delay and the data size of the data is larger than the reference size, the transmission method determination unit 233 determines to transmit the data by the embedded clock-scheme differential signal transmission circuit 21.

### Effect of Embodiment 3

As described above, the data transmission device 10 according to Embodiment 3 determines by which circuit to transmit data, considering both the data size of the data and the control information included in the transmission instruction. Hence, effects of both Embodiments 1 and 2 can be obtained.

### Embodiment 4

In Embodiment 4, an order of considering a transmission-object data and a transmission instruction is different from that of Embodiment 3. In Embodiment 4, this difference will be described, and a description on the same point will be omitted.

***Description of Behavior***

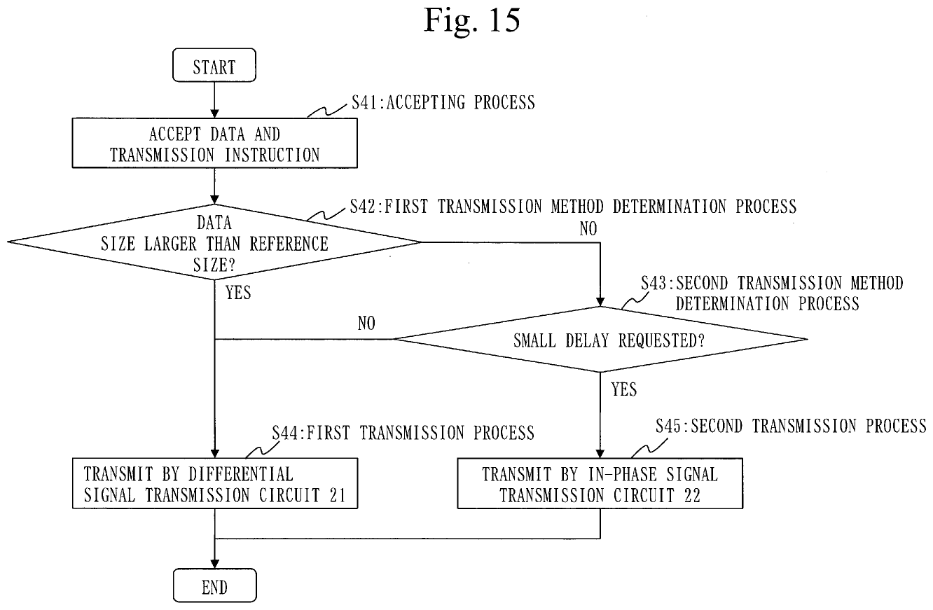

Behavior of a data transmission device 10 according to Embodiment 4 will be described with referring to FIG. 15.

A process of step S41, a process of step S44, and a process of step S45 of FIG. 15 are respectively the same as a process of step S31, a process of step S34, and a process of step S35 of FIG. 14.

(Step S42 of FIG. 15: First Transmission Method Determination Process)

A transmission method determination unit 233 a transmission method determination unit 233 determines whether or not a data size of transmission-object data accepted in step S41 is larger than a reference size.

If the data size of the data is equal to or smaller than the reference size, the transmission method determination unit 233 advances processing to step S43. On the other hand, if the data size of the data is larger than the reference size, the transmission method determination unit 233 advances processing to step S44. That is, in a case where the data size of the data is larger than the reference size, the transmission method determination unit 233 determines to transmit the data by an embedded clock-scheme differential signal transmission circuit 21.

(Step S43 of FIG. 15: Second Transmission Method Determination Process)

The transmission method determination unit 233 transmission method determination unit 233 determines whether or not control information included in a transmission instruction accepted in Step S41 requests a small delay.

If the control information does not request a small delay, the transmission method determination unit 233 advances processing to step S44. That is, in a case where the data size of the data is equal to or smaller than the reference size and the control information indicates not requesting a small delay, the transmission method determination unit 233 determines to transmit the data by an embedded clock-scheme differential signal reception circuit 31. On the other hand, if the control information requests a small delay, the transmission method determination unit 233 advances processing to step S45. That is, in a case where the data size of the data is equal to or smaller than the reference size and the control information requests a small delay, the transmission method determination unit 233 determines to transmit the data by an in-phase signal reception circuit 32.

### Effect of Embodiment 4

As described above, the data transmission device 10 according to Embodiment 4 determines by which circuit to transmit data, considering both the data size of the data and the control information included in the transmission instruction. Hence, effects of both Embodiments 1 and 2 can be obtained.

### Embodiment 5

In Embodiment 5, a parameter in embedded clock-scheme differential signal transmission is transmitted by an in-phase signal transmission circuit 22. This is where Embodiment 5 is different from Embodiments 1 to 4. In Embodiment 5, this difference will be described, and a description on the same point will be omitted.

***Outline Description***

When performing embedded clock-scheme differential signal transmission, bidirectional communication need be performed between computers 50 which perform data transmission. For this reason, a data transmission device 10 of each computer 50 which perform data transmission need be provided with both a transmission-side circuit 20 and a reception-side circuit 30.

When performing embedded clock-scheme differential signal transmission, prior to transmitting transmission-object data, a parameter concerning a behavior condition such as a clock signal and a signal strength is notified to a counterpart, and a parameter is received from the counterpart likewise. The transmission-side circuit 20 and the reception-side circuit 30 are set to behave based on the exchanged parameters.

In the embedded clock-scheme differential signal transmission circuit 70 illustrated in FIGS. 4 and 5, this parameter exchange is performed by embedded clock-scheme differential signal transmission. Hence, data transmission cannot be performed during parameter exchange.

***Description of Configuration***

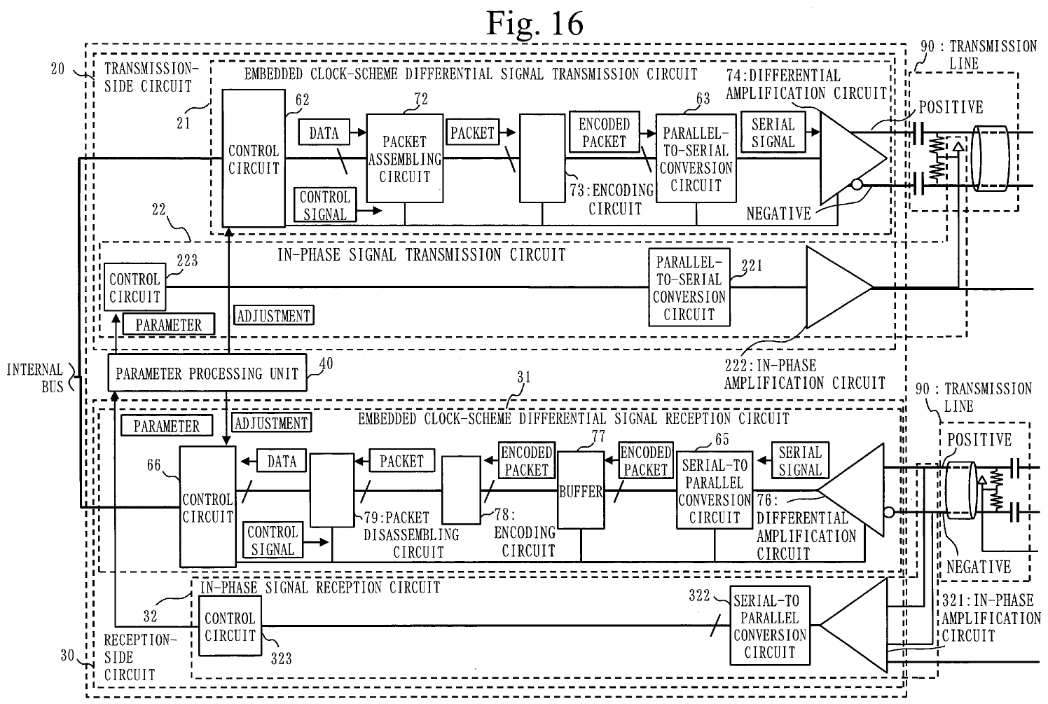

A configuration of the data transmission device 10 according to Embodiment 5 will be described with referring to FIG. 16.

The data transmission device 10 is provided with a parameter processing unit 40. This is where this data transmission device 10 is different from the data transmission device 10 illustrated in FIGS. 9 and 10. In place of the control circuit 23, the transmission-side circuit 20 is provided with a control circuit 62 in an embedded clock-scheme differential signal transmission circuit 21, and provided with a control circuit 223 in the in-phase signal transmission circuit 22. This is where this transmission-side circuit 20 is different from the transmission-side circuit 20 illustrated in FIG. 9. Also, in place of the control circuit 33, the reception-side circuit 30 of the data transmission device 10 is provided with a control circuit 66 in an embedded clock-scheme differential signal reception circuit 31, and provided with a control circuit 323 in an in-phase signal reception circuit 32. This is where this reception-side circuit 30 is different from the reception-side circuit 30 illustrated in FIG. 10.

***Description of Behavior***

When performing embedded clock-scheme differential signal transmission, the parameter processing unit 40 transmits a parameter indicating a behavior condition for transmitting the data by the embedded clock-scheme differential signal transmission circuit 21, to the counterpart using the in-phase signal transmission circuit 22.

Specifically, the parameter processing unit 40 outputs the parameter to the control circuit 223 of the in-phase signal transmission circuit 22. Then, a parallel-to-serial conversion circuit 221 converts the parameter into a serial signal, and an in-phase amplification circuit 222 amplifies an in-phase output and supplies the amplified output to a transmission line 90.

Likely, the counterpart transmits a parameter by in-phase signal transmission. In the in-phase signal reception circuit 32, an in-phase amplification circuit 321 amplifies an in-phase input of the parameter transmitted from the counterpart received via the transmission line 90. A serial-to-parallel conversion circuit 322 converts the serial signal into a parallel signal to generate a parameter.

### Effect of Embodiment 5

As described above, the data transmission device 10 according to Embodiment 5 performs parameter exchange in embedded clock-scheme differential signal transmission, with using the in-phase signal transmission circuit 22. Therefore, data transmission by embedded signal transmission can be performed even during parameter exchange.

***Other Configurations***

<Modification 1>

Unlike Embodiments 1 to 4, as illustrated in FIG. 16, Embodiment 5 does not have a configuration in which a control circuit 23 determines between the embedded clock-scheme differential signal transmission circuit 21 and the in-phase signal transmission circuit 22, by which circuit to transmit data. Even when Embodiment 5 has a configuration in which by which circuit to perform data transmission is determined in the same manner as in Embodiments 1 to 4, it is possible to perform parameter exchange using the in-phase signal transmission circuit 22.

### REFERENCE SIGNS LIST

10: data transmission device; 20: transmission-side circuit; 21: embedded clock-scheme differential signal transmission circuit; 22: in-phase signal transmission circuit; 221: parallel-to-serial conversion circuit; 222: in-phase amplification circuit; 223: control circuit; 23: control circuit; 231: data accepting unit; 232: instruction accepting unit; 233: transmission method determination unit; 234: instruction execution unit; 30: reception-side circuit; 31: embedded clock-scheme differential signal reception circuit; 32: in-phase signal reception circuit; 321: in-phase amplification circuit; 322: serial-to-parallel conversion circuit; 323: control circuit; 33: control circuit; 331: differential data issuing unit; 332: in-phase data issuing unit; 333: notice issuing unit; 40: parameter processing unit; 50: computer; 51: I/F; 52: transmission-side circuit; 53: reception-side circuit; 60: serial transmission circuit; 61: transmission-side circuit; 62: control circuit; 63: parallel-to-serial conversion circuit; 64: reception-side circuit; 65: serial-to-parallel conversion circuit; 66: control circuit; 70: embedded clock-scheme differential signal transmission circuit; 71: transmission-side circuit; 72: packet assembling circuit; 73: encoding circuit; 74: differential amplification circuit; 75: reception-side circuit; 76: differential amplification circuit; 77: buffer; 78: decoding circuit; 79: packet disassembling circuit; 90: transmission line.

1-7. (canceled)

8. A data transmission device comprising:
processing circuitry
to accept data,
to accept a transmission instruction for the accepted data,
to determine between an embedded clock-scheme differential signal transmission circuit and an in-phase signal transmission circuit, by which circuit to transmit the data, based on at least either one of the data and the accepted transmission instruction, and
to cause the determined circuit to transmit the data.

9. The data transmission device according to claim 8,
wherein in a case where a data size of the data is larger than a reference size, the processing circuitry determines to transmit the data by the differential signal transmission circuit; and in a case where the data size of the data is equal to or smaller than the reference size, the processing circuitry determines to transmit the data by the in-phase signal transmission circuit.

10. The data transmission device according to claim 8,
wherein the transmission instruction includes control information indicating whether or not requesting a small delay, and
wherein in a case where the control information indicates not requesting a small delay, the processing circuitry determines to transmit the data by the differential signal transmission circuit; and in a case where the control information indicates requesting a small delay, the processing circuitry determines to transmit the data by the in-phase signal transmission circuit.

11. The data transmission device according to claim 8,
wherein the transmission instruction includes control information indicating whether or not requesting a small delay, and
wherein in each of a case where the control information indicates requesting a small delay, and a case where the control information indicates not requesting a small delay and a data size of the data is equal to or smaller than a reference size, the processing circuitry determines to transmit the data by the in-phase signal reception circuit; and in a case where the control information indicates not requesting a small delay and the data size of the data is larger than the reference size, the processing circuitry determines to transmit the data by the differential signal transmission circuit.

12. The data transmission device according to claim 8,
wherein the transmission instruction includes control information indicating whether or not requesting a small delay, and
wherein in each of a case where a data size of the data is larger than a reference size, and a case where the data size of the data is equal to or smaller than the reference size and the control information indicates not requesting a small delay, the processing circuitry determines to transmit the data by the differential signal transmission circuit; and in a case where the data size of the data is equal to or smaller than the reference size and the control information indicates requesting a small delay, the processing circuitry determines to transmit the data by the in-phase signal transmission circuit.

13. The data transmission device according to claim 8,
wherein the processing circuitry transmits a parameter indicating a behavior condition for transmitting the data by the differential signal transmission circuit, using the in-phase signal transmission circuit.

14. The data transmission device according to claim 9,
wherein the processing circuitry transmits a parameter indicating a behavior condition for transmitting the data by the differential signal transmission circuit, using the in-phase signal transmission circuit.

15. The data transmission device according to claim 10,
wherein the processing circuitry transmits a parameter indicating a behavior condition for transmitting the data by the differential signal transmission circuit, using the in-phase signal transmission circuit.

16. The data transmission device according to claim 11,
wherein the processing circuitry transmits a parameter indicating a behavior condition for transmitting the data by the differential signal transmission circuit, using the in-phase signal transmission circuit.

17. The data transmission device according to claim 12,
wherein the processing circuitry transmits a parameter indicating a behavior condition for transmitting the data by the differential signal transmission circuit, using the in-phase signal transmission circuit.

18. A data transmission method comprising:
accepting data;
accepting a transmission instruction for the data;
determining between an embedded clock-scheme differential signal transmission circuit and an in-phase signal transmission circuit, by which circuit to transmit the data, based on at least either one of the data and the transmission instruction; and
causing the determined circuit to transmit the data.
